(19) United States
(12) Patent Application Publication
(10) Pub. No.: US 2021/0356623 A1
(43) Pub. Date: Nov. 18, 2021

(54) Rock Reservoir Structure Characterization Method, Device, Computer-Readable Storage Medium and Electronic Equipment

(71) Applicant: INSTITUTE OF GEOLOGY AND GEOPHYSICS CHINESE ACADEMY OF SCIENCES (IGGCAS), Beijing (CN)

(72) Inventors: Xiaocai SHAN, Beijing (CN); Yongjian ZHOU, Beijing (CN); Wei XIN, Beijing (CN); Fei TIAN, Beijing (CN); Changchun YANG, Beijing (CN)

(21) Appl. No.: 16/992,260

(22) Filed: Aug. 13, 2020

(30) Foreign Application Priority Data
May 12, 2020 (CN) 202010395655.9

(51) Int. Cl. G01V 99/00; G06F 17/18; G06F 17/14; G06F 30/20

(52) U.S. Cl. CPC G01V 99/005; G06F 17/18; G06N 20/00; G06F 30/20; G06F 17/14

(57) ABSTRACT

Rock reservoir structure characterization method comprises: acquiring a three-dimensional seismic data volume of a rock reservoir to be characterized; performing a transformation on all the intrinsic mode function components obtained through decomposition to obtain time-frequency spectrum of each intrinsic mode function component, and adding the time-frequency spectrums of all the components to obtain the time-frequency spectrums of the seismic data; performing cross-correlation between each of the time-frequency components of the near-well seismic traces and the synthetic seismic trace obtained by logging data of the same well, and screening out a sensitive component with the highest correlation degree as an input feature, and performing fuzzy C-means clustering and spatial smoothing on the sensitive component with the highest correlation degree to obtain a seismic facies with set standard division; and depicting the rock reservoir according to the seismic facies divided by the set standard.

### CROSS-REFERENCE TO RELATED APPLICATIONS

The application claims priority to Chinese patent application No. 202010395655.9, filed on May 12, 2020, the entire contents of which are incorporated herein by reference.

### TECHNICAL FIELD

The present disclosure relates to the technical field of rock reservoir structure characterization method, in particular to a rock reservoir structure characterization method, device, computer-readable storage medium and electronic equipment.

### BACKGROUND

A rock reservoir structure characterization method by the empirical mode decomposition and the KNN clustering algorithm in the prior art has the following technical defects: different seismic traces have different numbers of IMF components, and seismic sections of the corresponding IMF component are not continuous along seismic horizons; a quantitative constraint information form well logging is not taken into consideration; in the KNN clustering method, each waveform data only belongs to one sedimentary facies, without its membership to each sedimentary facies, which is not conducive to a further smoothed analysis of clustering results. In the prior art, another rock reservoir structure characterization method by SST and the K-Means clustering algorithm has the following technical defects: different seismic traces have different numbers of IMF components, and the IMF components reconstructed by a certain frequency band range are not continuous along seismic horizons; a quantitative constraint information form well logging is not taken into consideration, and the frequency band segmentation is carried out manually; in the K-means clustering method, each waveform data only belongs to one sedimentary facies, without its membership to each sedimentary facies, which is not conducive to a further smoothed analysis of clustering results.

### SUMMARY

Therefore, the disclosure provides a rock reservoir structure characterization method containing geological constraints, device, computer-readable storage medium and electronic equipment based on complete ensemble empirical mode decomposition with adaptive noise, the Hilbert transformation and the fuzzy C-means clustering algorithm. It can solve the problem that the existing reservoir depiction techniques based on a data-driven machine learning method cannot guarantee validity of input features and also reliability and noise resistance of clustering, so that it is more suitable for practical application.

The disclosure provides a technical solution of a rock reservoir structure characterization method, characterized by comprising the steps of:

acquiring a three-dimensional seismic data volume of a key stratum of a rock reservoir to be characterized;

performing a data decomposition on the three-dimensional seismic data volume of the key stratum of the rock reservoir to be characterized to obtain a plurality of intrinsic mode function components;

performing a data transformation on all the intrinsic mode function components to obtain time-frequency spectrums of all the intrinsic mode function components;

adding the time-frequency spectrums of all intrinsic mode functions to obtain time-frequency spectrums of seismic data;

performing a cross-correlation between each of the time-frequency components of the near-well seismic traces and the synthetic seismic trace obtained by logging data of the same well, and screening out a sensitive time-frequency component with the highest correlation degree;

using the sensitive time-frequency component with the highest correlation degree as an input feature, and performing fuzzy C-means clustering and spatial smoothing for seismic facies division to obtain seismic facies with set standard division; and

depicting the rock reservoir to be characterized according to the seismic facies divided by the set standard to obtain the rock reservoir structure characterization.

Further, in the step of performing a data decomposition on the three-dimensional seismic data volume of the key stratum of the rock reservoir to be characterized to obtain a plurality of intrinsic mode function components, the data decomposition specifically adopts a complete ensemble empirical mode decomposition with adaptive noise method.

Further, in the step of performing a data transformation on all the intrinsic mode function components to obtain time-frequency spectrums of all the intrinsic mode function components, a Hilbert transformation method is specifically adopted for performing the data transformation on all the intrinsic mode function components.

Further, in the step of performing a data decomposition on the three-dimensional seismic data volume of the key stratum of the rock reservoir to obtain a plurality of intrinsic mode function components, a specific operation formula comprises:

let x[n] be target data, and the complete ensemble empirical mode decomposition with adaptive noise and computation of time-frequency spectrums is described by the following algorithm:

(1) subjecting all xⁱ[n]=x[n]+ε₀wⁱ[n](i=1, 2, . . . , I) to the empirical mode decomposition (EMD) to obtain their first mode IMF₁ⁱ [n], and calculating

$$[ n ] = \frac{1}{I} {\sum }_{i = 1}^{I} {IMF}_{1}^{i} [ n ] = \overline{{IMF}_{1}} [ n ]$$

wherein, x[n] is a seismic trace signal, wⁱ[n](i=1, 2, . . . , I) are different white Gaussian noises;

(2) calculating a first residual error in the first stage (k=1), as shown in the formula:

r1[n]=x[n]− [symbol] [n]

(3) decomposing to implement r₁[n]+ε₁E₁(wⁱ[n]), I=1, . . . , I, until the first EMD mode is acquired for defining a second mode:

$$[ n ] = \frac{1}{I} {\sum }_{i = 1}^{I} {E}_{1} ( {r}_{1} [ n ] + {ɛ}_{1} {E}_{1} ( {w}^{i} [ n ] ) )$$

(4) for k=2, . . . , K, calculating a kth residual error:

rₖ[n]=r₍ₖ₋₁₎[n]− [symbol] [n]

(5) decomposing to implement rₖ[n]+εₖEₖ(wⁱ[n]), i=1, . . . , I, until the first EMD mode is acquired for defining a (k+1)th mode:

$$[ n ] = \frac{1}{I} {\sum }_{i = 1}^{I} {E}_{1} ( {r}_{k} [ n ] + {ɛ}_{k} {E}_{k} ( {w}^{i} [ n ] ) )$$

(6) going to a fourth step in the next k;

circularly executing steps (4)-(6) until the obtained residual error is no longer decomposable, i.e. the residual error has at most one pole, and the final residual error Res[n] satisfies:

R[n]=x[n]−Σₖ₌₁^{K}

[symbol]

wherein K represents the total number of modes; thus, a given signal x[n] is represented as:

x[n]=Σₖ₌₁^{K} [symbol] +R[n].

Further, in the step of performing data transformation on all the intrinsic mode function components to obtain time-frequency spectrums of all the intrinsic mode function components, a specific operation formula comprises:

$$y ( t ) = H [ x ( t ) ] = x ( t ) * \frac{1}{π t}$$

wherein x(t) is each intrinsic mode function IMF, y(t) is a Hilbert transform of x(t), and * represents a convolution symbol;

z(t)=x(t)+iy(t)=R(t)exp[iθ(t)]

wherein z(t) is a complex domain analytic signal of x(t), θ(t) is an instantaneous phase, and R(t) is an instantaneous amplitude, and is defined as:

R(t)=\sqrt{x²(t)+y²(t)}

an instantaneous frequency f(t) is defined as a first derivative of the instantaneous phase θ(t),

$$f ( t ) = \frac{1}{2 π} \frac{d θ ( t )}{dt} \text{;}$$

the calculation formula of the instantaneous frequency is as follows:

$$f ( t ) = \frac{1}{2 π} \frac{x ( t ) {y}^{′} ( t ) - {x}^{′} ( t ) y ( t )}{{x}^{2} ( t ) + {y}^{2} ( t )} \text{;}$$

wherein, ′ denotes a derivative for time Further, in the step of performing a cross-correlation between each of the time-frequency components of the near-well seismic traces and the synthetic seismic trace obtained by logging data of the same well, and screening out a sensitive time-frequency component with the highest correlation degree, a specific operation formula at each frequency is as follows:

max((f*g)(τ))=max(∫_{-∞}^{+∞}f*(ω,t)g(ω,t+τ)dt)

wherein,

max((f*g)(τ)) is a maximum value of the cross-correlation function,

f*(ω,t) is a certain time-frequency component of the near-well seismic trace;

g(ω,t) is a synthetic seismic trace obtained from the logging data,

t is a parameter for performing integral addition on two signals, and

τ is a parameter for a cross-correlation result, indicating different delays at which the cross-correlation values of the two signals differ.

Further, in the step of using the sensitive time-frequency component as an input feature, and performing fuzzy C-means clustering (FCM) and spatial smoothing for seismic facies division to obtain seismic facies with set standard division, a specific operation formula comprises:

FCM tries to find a fuzzy cluster of a set of data points xⱼ∈ [symbol] ^{d}(j=1, . . . , N), minimizing a cost function:

J(U,M)=Σᵢ₌₁^{c}Σⱼ₌₁^{N}(μ_{i,j})^{m}Dᵢⱼ,

wherein, U=[μ_{i,j}]_{cxN} is a fuzzy division matrix, μi,j∈[0,1] is a membership coefficient of j^{th} data in the i^{th} cluster; M=[m₁, m₂, . . . , m_{c}] is a clustering prototype (mean or center) matrix; m∈[1, ∞) is a fuzzification parameter, usually set to 2; Dᵢⱼ=D(xⱼ, mᵢ) is a distance measure between xⱼ and mᵢ, using an Euclidean L₂ norm distance function, and the fuzzy C-means clustering method of seismic waveform comprises the steps of:

(1) selecting a time window of a waveform to be extracted, xⱼ∈ [symbol] ^{d}(j=1, . . . , N), wherein xⱼ is the jth waveform, d is the sampling number in the time window and represents a length of the window, and N is the number of waveforms;

(2) selecting appropriate values of m and c and a small positive number ε, randomly initializing the prototype matrix M, and making the step variable t=0;

(3) calculating (when t=0) or updating (when t>0) a membership matrix U:

$${μ}_{ij}^{( t + 1 )} = 1 \text{/} ( {\sum }_{l = 1}^{c} {( \frac{{D}_{lj}}{{D}_{ij}} )}^{1 \text{/} ( 1 - m )} ) ,$$

for i=1, . . . , c and j=1, . . . , N;

(4) updating the prototype matrix M:

mᵢ^{(t+1)}=(Σⱼ₌₁^{N}(μᵢⱼ^{(t+1)})^{m}xⱼ)/(Σⱼ₌₁^{N}(μᵢⱼ^{(t+1)})^{m}), where i=1, . . . ,c;

(5) repeating the steps (2)-(3) until ∥M^{(t+1)}−M^{(t)}∥<ε; and if μ_{l,j} is a largest one in μ_{i,j}(i=1, . . . , c), the jth waveform is assigned to the first cluster.

A rock reservoir structure characterization device, characterized by comprising:

a three-dimensional seismic data volume acquisition unit configured for acquiring a three-dimensional seismic data volume of a key stratum of a rock reservoir to be characterized;

a data decomposition unit configured for performing a data decomposition on the three-dimensional seismic data volume of the key stratum of the rock reservoir to be characterized to obtain a plurality of intrinsic mode function components;

a data transformation unit configured for performing data transformation on all the intrinsic mode function components to obtain time-frequency spectrums of all the intrinsic mode function components, and adding the time-frequency spectrums of all the intrinsic mode functions to obtain the time-frequency spectrums of the seismic data;

a data fitting unit configured for performing cross-correlation between each of the time-frequency components of the near-well seismic traces and the synthetic seismic trace obtained by logging data of the same well, and screening out a sensitive time-frequency component with the highest correlation degree;

a seismic facies division unit configured for using the sensitive time-frequency component with the highest correlation degree as an input feature, and performing fuzzy C-means clustering and spatial smoothing for seismic facies division to obtain seismic facies with set standard division; and

a rock reservoir structure characterization unit configured for depicting the rock reservoir to be characterized according to the seismic facies divided by the set standard to obtain the rock reservoir structure characterization to be characterized.

A computer-readable storage medium, characterized in that the computer-readable storage medium stores a rock reservoir structure characterization program thereon which, when executed by a processor, performs the steps of the rock reservoir structure characterization method.

An electronic equipment, characterized by comprising a memory and a processor, wherein the memory stores a rock reservoir structure characterization program thereon which, when executed by the processor, performs the steps of the rock reservoir structure characterization method.

According to the rock reservoir structure characterization based on the fuzzy C-means clustering algorithm by the rock reservoir structure characterization method, device, the computer-readable storage medium and the electronic equipment provided by the disclosure, the rock reservoir structure characterization can reduce the interference caused by deep weak amplitude and noise, fully extract multi-scale features of waveforms, strengthen the constraint of actual logging data, and give consideration to the transverse continuity of seismic waveforms in the process of feature extraction and classification of seismic data. Therefore, it can guarantee the noise resistance and the reliability of the clustering result, and solve the problem that the existing reservoir depiction techniques based on a data-driven machine learning method cannot guarantee validity of input features and also reliability and noise resistance of clustering.

### BRIEF DESCRIPTION OF DRAWINGS

Various other advantages and benefits will become apparent to those of ordinary skill in the art upon reading the following detailed description of the preferred embodiments. The drawings are only for the purpose of illustrating preferred embodiments and are not to be construed as limiting the disclosure. Also, throughout the drawings, like reference numerals represent like parts. In the drawings:

FIG. 1 is a structurally schematic diagram of a rock reservoir structure characterization equipment of a hardware operating environment of a rock reservoir structure characterization method according to an embodiment solution of the present disclosure;

FIG. 2 is a schematic diagram of the rock reservoir structure characterization method according to an embodiment solution of the present disclosure;

FIG. 3 is a work area range diagram of the rock reservoir structure characterization method according to an embodiment solution of the present disclosure;

FIG. 4 is an exemplary two-dimensional cross-sectional view of a seismic signal of the rock reservoir structure characterization method according to an embodiment solution of the present disclosure;

FIG. 5 is an example of one-dimensional seismic trace data of the rock reservoir structure characterization method according to an embodiment solution of the present disclosure;

FIG. 6 is a graph of IMFs and residual errors obtained from the signal of FIG. 5 via CEEMDAN;

FIG. 7 is a time-frequency spectrum diagram of the signal of FIG. 5;

FIG. 8 is a two-dimensional cross-sectional view of sensitive frequency signal component in the time-frequency spectrum of the signal of FIG. 4;

FIG. 9 is a clustering result graph (using sensitive frequency components) of a target reservoir of a work area of the rock reservoir structure characterization method according to an embodiment solution of the present disclosure;

FIG. 10 is a clustering result graph (using original seismic signals) of a target reservoir of a work area of the rock reservoir structure characterization method according to an embodiment solution of the present disclosure; and

FIG. 11 is a schematic diagram illustrating a signal flow direction relationship between functional modules in a rock reservoir structure characterization device according to an embodiment solution of the present disclosure.

### DETAILED DESCRIPTION OF THE EMBODIMENTS

Exemplary embodiments of the present disclosure will be described in more detail below with reference to the accompanying drawings. While exemplary embodiments of the present disclosure are shown in the drawings, it is to be understood that the present disclosure may be implemented in various forms and should not be limited to the embodiments set forth herein. Rather, these embodiments are provided so that this disclosure will be thorough and complete, and will fully convey the scope of the disclosure to those skilled in the art.

The disclosure aims to solve the problems in the prior art, and provides a rock reservoir structure characterization method containing geological constraints, device, computer-readable storage medium and electronic equipment based on complete ensemble empirical mode decomposition with adaptive noise, the Hilbert transformation and the fuzzy C-means clustering algorithm. It can solve the problem that the existing reservoir depiction techniques based on a data-driven machine learning method cannot guarantee validity of input features and also reliability and noise resistance of clustering, so that it is more suitable for practical application.

Empirical Mode Decomposition (EMD), an adaptive data analysis method, can decompose any complex data set into a finite and usually a small number of Intrinsic Mode Functions (IMFs). The different intrinsic mode function components qualitatively represent different frequency band component information in a physical sense. This decomposition method is adaptive and is applicable to non-linear and non-stationary processes because the decomposition is based on local features of the data. However, EMD has the problems of large amplitude difference in the same mode, similar oscillation and mode mixing of different modes. To overcome these problems, the Ensemble Empirical Mode Decomposition (EEMD) performs EMD on the premise of adding white Gaussian noise to the signal, which solves the problem of mode mixing. However, reconstructed signal of EEMD includes residual noise, and different noise superposition modes produce different numbers of modes. The complete ensemble empirical mode decomposition with adaptive noise (CEEMDAN) can reconstruct an original signal accurately and separate the mixing modes with low computational cost, with great advantages.

If the seismic data is directly divided into several intrinsic mode functions and the seismic attributes along the stratum are extracted from the IMF components as features, there will be a great problem. In practice, we find that the numbers of intrinsic mode functions decomposed by different seismic traces are different, and the seismic traces profiles reconstructed directly by IMFs or by frequency bands are not continuous along seismic horizons. Therefore, for every seismic trace, Hilbert transform is carried out on all IMFs to obtain time-frequency spectrums of all the IMFs, the time-frequency spectrums of all IMFs are added to obtain time-frequency spectrums, and then a single sensitive time-frequency component is used for depicting the reservoir, which is more physically sensible.

Deep fracture-cave type carbonate reservoirs have obvious transverse heterogeneity, and it is difficult to find which frequency component can best reflect the real reservoir by qualitative analysis of interpreters. Therefore, we propose to make full use of the existing logging information as constraints, and to use cross-correlation between each of the time-frequency components of the near-well seismic traces and the synthetic seismic trace obtained by the logging of the same well to quantitatively decide which time-frequency component can best reflect the real reservoir.

Prior to applying waveform clustering, the key seismic horizon is used as a geological constraint to select a time slice window. In the application, a seismic data slice between the top of the T74 and the bottom of the T74 is selected, and the seismic data slice is at the position of a fracture-cave paleochannel reservoir. When selecting the appropriate number of typical waveforms, the prior geological knowledge of the target stratum, the existing logging data and the trial and error method should be correctly combined to make the best decision. Three clustering centers are selected in the present application to represent a paleochannel, a fracture cave and a rock matrix respectively.

In order to further illustrate the technical means and effects for achieving the intended purposes of the present disclosure, a rock structure characterization method, device, computer-readable storage medium and electronic equipment according to the present disclosure, as well as embodiments, structures, features and effects thereof, are described in detail below with reference to the accompanying drawings and preferred embodiments. In the following description, different “one embodiment” or “an embodiment” means not necessarily the same embodiment. Furthermore, the features, structures, or characteristics of one or more embodiments may be combined in any suitable form.

The term “and/or” herein is merely an association that describes associated objects, meaning that there may be three relationships, e.g., A and/or B can be specifically understood as that A and B may be included together, A may be present alone or B may be present alone, and any of the above three cases may be provided.

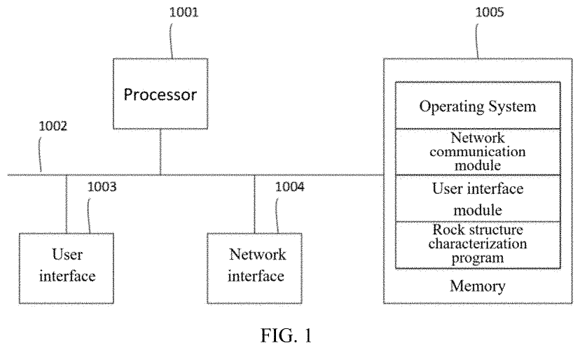

Referring to FIG. 1, there is shown a structurally schematic diagram of a rock reservoir structure characterization equipment of a hardware operating environment according to an embodiment solution of the present disclosure.

As shown in FIG. 1, the rock structure characterization equipment may include a processor 1001, such as a central processing unit (CPU), a communication bus 1002, a user interface 1003, a network interface 1004, and a memory 1005. The communication bus 1002 is used to enable connection communication between these components. The user interface 1003 may include a display, an input unit such as a keyboard, and the optional user interface 1003 may also include a standard wired interface and wireless interface. The network interface 1004 may optionally include a standard wired interface and wireless interface (e.g., a Wireless-Fidelity (WI-FI) interface). The memory 1005 may be a high-speed random-access memory (RAM) or a stable non-volatile memory (NVM), such as a magnetic disk memory. The memory 1005 may optionally be a storing device separate from the afore mentioned processor 1001.

It will be appreciated by those skilled in the art that the structure shown in FIG. 1 does not constitute a limitation on the rock structure characterization equipment, and may include more or fewer components than shown, or may combine certain components, or may be arranged by different components.

As shown in FIG. 1, a memory 1005, which is a storage medium, may include an operating system, a data storage module, a network communication module, a user interface module, and a rock structure characterization program.

In the rock structure characterization equipment shown in FIG. 1, the network interface 1004 is mainly configured for data communication with a network server; the user interface 1003 is mainly configured for performing data interaction with a user; the processor 1001 and the memory 1005 in the rock structure characterization equipment can be arranged in the rock structure characterization equipment, and the rock structure characterization equipment calls a rock structure characterization program stored in the memory 1005 by the processor 1001 and executes the rock structure characterization method provided by the embodiment of the disclosure.

### Embodiment 1

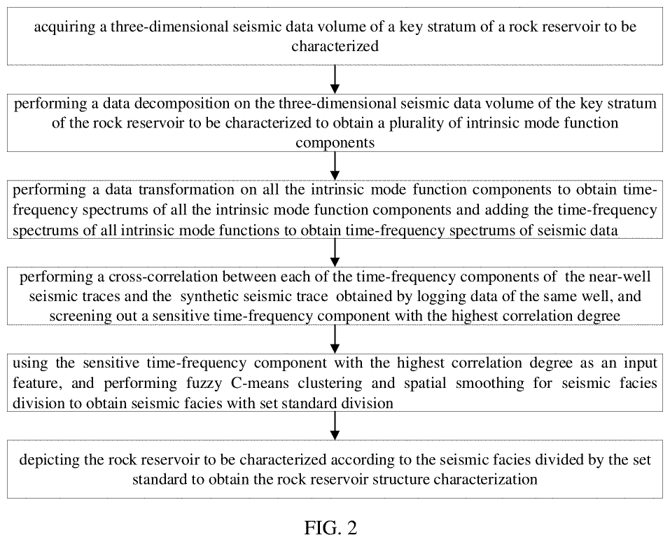

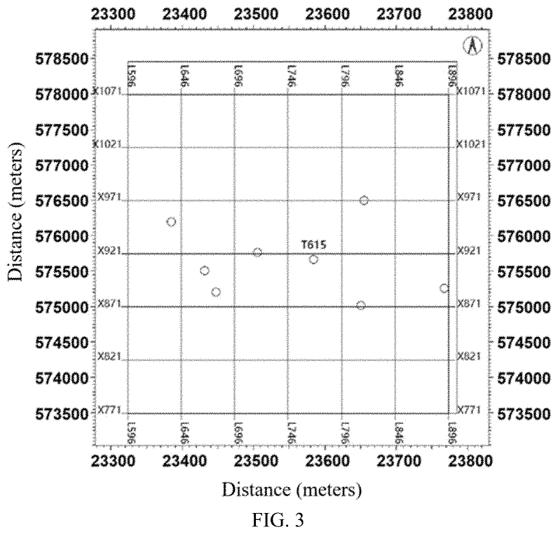

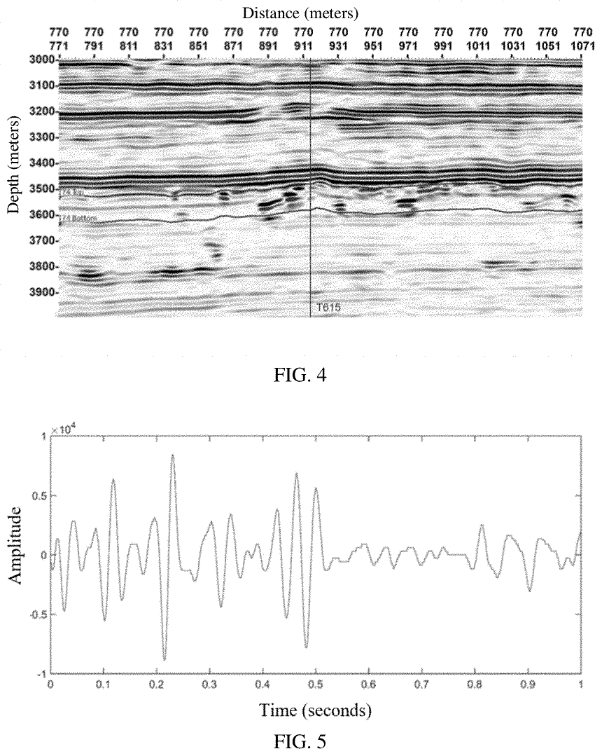

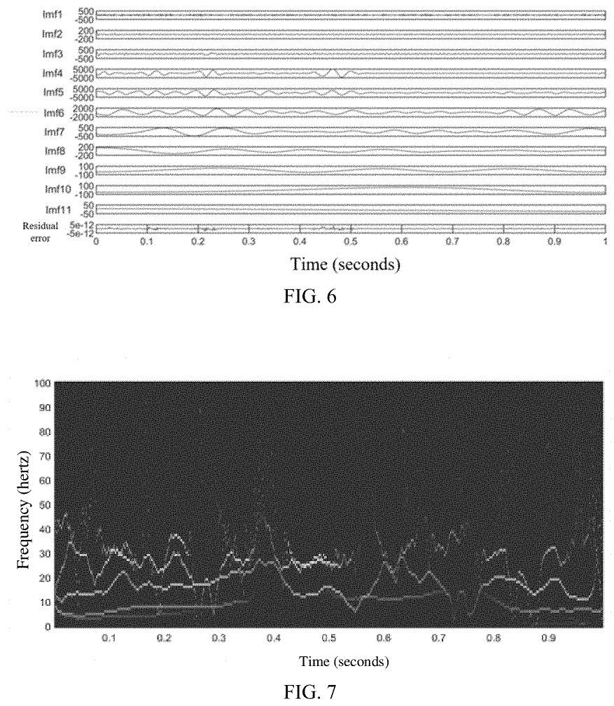

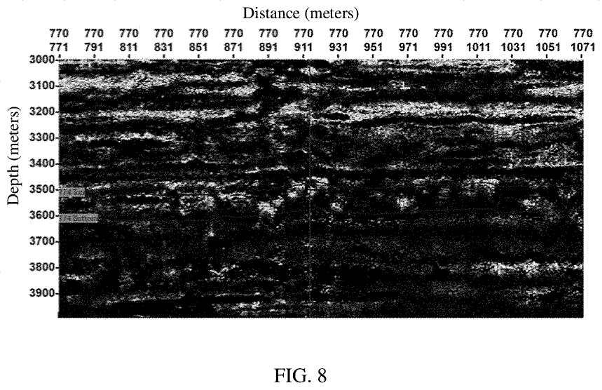

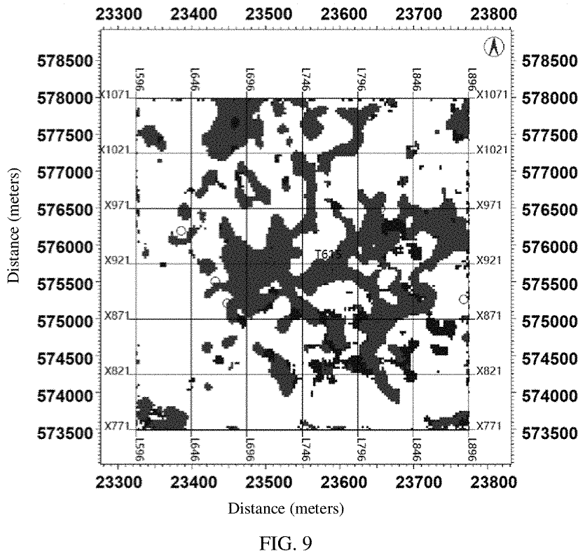

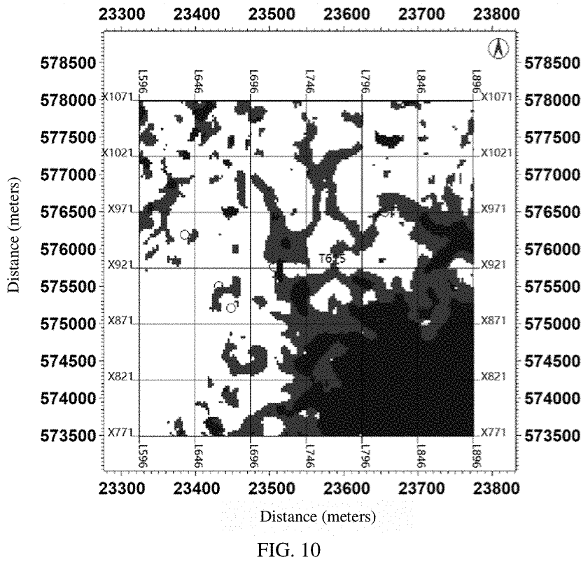

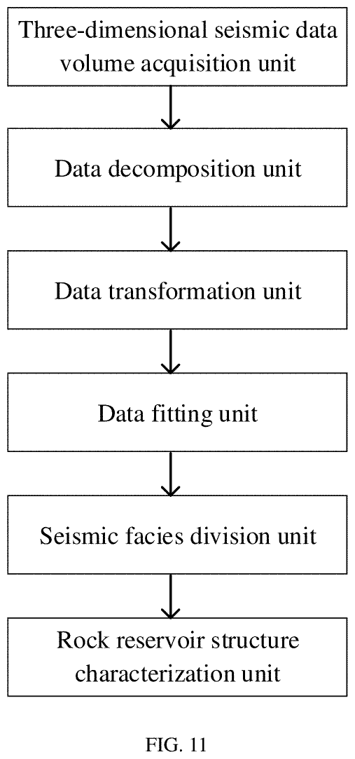

Referring to FIG. 2, the rock reservoir structure characterization method provided by the embodiment 1 of the disclosure comprises the steps of:

acquiring a three-dimensional seismic data volume of a key stratum of a rock reservoir to be characterized; in the embodiment, the three-dimensional seismic data volume refers to a data volume obtained by seismic migration data, and can display basic stratum structures, which is very important for finding and depicting a target reservoir. The specific data form is N*M*T, wherein N represents N traces of data along the length direction of the work area, M represents M traces of data along the width direction of the work area, the work area has N*M traces of seismic data, and T is the longitudinal depth of each trace of data (i.e. representing the longitudinal depth of the work area). Assuming that N=200, M=100, T=100, the seismic channel spacing in the length-width direction is 20 m, and the time-depth is converted to 10 m/Δ t, this data represents information within a work area 4 km in length*2 km in width*1 km in depth. In this embodiment, the key stratums refer to the top and bottom of the target reservoir, and are manually calibrated empirically by interpreters in actual engineering.

Performing a data decomposition on the three-dimensional seismic data volume of the key strata of the rock reservoir to be characterized to obtain a plurality of intrinsic mode function components.

Performing a data transformation on all the intrinsic mode function components to obtain time-frequency spectrums of all the intrinsic mode function components, and adding the time-frequency spectrums of all the intrinsic mode functions to obtain the time-frequency spectrums of the seismic data; in the embodiment, for all N*M channels of seismic data, a plurality of intrinsic mode functions of each trace of seismic data can be obtained by the complete ensemble empirical mode decomposition with adaptive noise, and time-frequency information of each trace of seismic data can be obtained by further Hilbert-Huang transformation. Near-well seismic traces are part of N*M traces of seismic data and refer to seismic traces around the wells site. Each time-frequency component of the near-well seismic traces and the synthetic seismic trace obtained by the logging data of the same well are subjected to cross-correlation analysis, so as to determine which frequency component can best represent seismic response of a real stratum, and then determine the sensitive time-frequency component of the seismic data in the whole work area. The fuzzy C-means clustering is further performed on the sensitive time-frequency component of the seismic data in the whole work area.

Performing a cross-correlation between each of the time-frequency components of the near-well seismic traces and the synthetic seismic trace obtained by logging data of the same well, and screening out a sensitive time-frequency component with the highest correlation degree; in the embodiment, logging curves are a plurality of groups of data curves measured during well drilling, reflecting different lithology and strata features. The logging curves includes a resistivity curve, an acoustic wave curve, a natural potential curve, a microelectrode curve, a density curve, etc.

The general process for making synthetic seismic trace is as follows: a reflection coefficient is calculated from the acoustic and density logging curves, and the reflection coefficient is convolved with an extracted seismic wavelet to obtain a synthetic seismic trace.

Using the sensitive time-frequency component with the highest correlation degree as an input feature, and performing fuzzy C-means clustering and spatial smoothing for seismic facies division to obtain seismic facies with set standard division; wherein, the fuzzy C-means clustering algorithm is specifically as follows: “assuming that the sample set is xⱼ∈ [symbol] ^{d}(j=1, . . . , N), with c fuzzy groups divided and cluster centers m1, m2, . . . , mc of each group calculated, so that the target function is minimized. In the algorithm, c is the human setting of the interpreter according to the geological understanding of the work area. In an example work area, we set c as 3. The reason is that one type represents a deep rock matrix, one part of types represents deep carbonate paleochannel facies, and one part of types represent fracture-cave reservoirs developed near the paleochannel facies. In the embodiment, the two-dimensional Gaussian filtering is smoothly used to perform spatial smoothing, and the smoothing result is rounded.

Depicting the rock reservoir according to the seismic facies divided by the set standard to obtain the rock reservoir structure characterization. In this embodiment, the seismic facies is a distributed range of three-dimensional seismic reflection units and comprised of groups of reflected waves that differ from adjacent seismic facies units. Different seismic facies can reflect different sedimentary facies. In the resulting seismic facies distribution diagram, light color represents a paleochannel facies, deep color represents a fracture-cave type reservoir, and white represents a rock matrix. Black circles represent each well site.

The rock reservoir structure characterization method provided by the disclosure is a rock reservoir structure characterization based on the fuzzy C-means clustering algorithm, can reduce the interference caused by deep weak amplitude and noise, fully extract multi-scale features of waveforms, strengthen the constraint of actual logging data, and give consideration to the transverse continuity of seismic waveforms in the process of feature extraction and classification of seismic data. Therefore, it can guarantee the noise resistance and the reliability of the clustering result, and solve the problem that the existing reservoir depiction techniques based on a data-driven machine learning method cannot guarantee validity of input features and also reliability and noise resistance of clustering.

In the step of performing a data decomposition on the three-dimensional seismic data volume of the key stratum of the rock reservoir to obtain a plurality of intrinsic mode function components, the data decomposition specifically adopts a complete ensemble empirical mode decomposition with adaptive noise method.

In the step of performing a data transformation on all the intrinsic mode function components to obtain time-frequency spectrums of all the intrinsic mode function components, a Hilbert transformation method is specifically adopted for performing the data transformation on all the intrinsic mode function components.

In the step of performing a data decomposition on the three-dimensional seismic data volume of the key strata of the rock reservoir to obtain a plurality of intrinsic mode function components, a specific operation formula comprises:

let x[n] be target data, and the complete ensemble empirical mode decomposition with adaptive noise and computation of time-frequency spectrums is described by the following algorithm:

(1) subjecting all xⁱ[n]=x[n]+ε₀wⁱ[n](i=1, 2, . . . , I) to the empirical mode decomposition (EMD) to obtain their first mode IMF₁ⁱ [n], and calculating

$$[ n ] = \frac{1}{I} {\sum }_{i = 1}^{I} {IMF}_{1}^{i} [ n ] = \overline{{IMF}_{1}} [ n ]$$

wherein, x[n] is a seismic trace signal, wⁱ[n](i=1, 2, . . . , I) are different white Gaussian noises;

(2) calculating a first residual error in the first stage (k=1), as shown in the formula:

r₁[n]=x[n]− [symbol] [n]

(3) decomposing to implement r₁[n]+ε₁E₁(wⁱ[n]), I=1, . . . , I, until the first EMD mode is acquired for defining a second mode:

$$[ n ] = \frac{1}{I} {\sum }_{i = 1}^{I} {E}_{1} ( {r}_{1} [ n ] + {ɛ}_{1} {E}_{1} ( {w}^{i} [ n ] ) )$$

(4) for k=2, . . . , K, calculating a kth residual error:

rₖ[n]=r₍ₖ₋₁₎[n]− [symbol] [n]

(5) decomposing to implement rₖ[n]+εₖEₖ(wⁱ[n]), i=1, . . . , I, until the first EMD mode is acquired for defining a (k+1)th mode:

$${( k + 1 )}_{} [ n ] = \frac{1}{I} {\sum }_{i = 1}^{I} {E}_{1} ( {r}_{k} [ n ] + {ɛ}_{k} {E}_{k} ( {w}^{i} [ n ] ) )$$

(6) going to a fourth step in the next k;

circularly executing steps (4)-(6) until the obtained residual error is no longer decomposable, i.e. the residual error has at most one pole, and the final residual error satisfies:

R[n]=x[n]−Σₖ₌₁^{K}

[symbol]

wherein K represents the total number of modes; thus, a given signal x[n] can be represented as:

x[n]=Σₖ₌₁^{K} [symbol] +R[n].

In the step of performing data transformation on all the intrinsic mode function components to obtain time-frequency spectrums of all the intrinsic mode function components, a specific operation formula comprises:

$$y ( t ) = H [ x ( t ) ] = x ( t ) * \frac{1}{π t}$$

wherein x(t) is each intrinsic mode function IMF, y(t) is a Hilbert transform of x(t), and * represents a convolution symbol;

z(t)=x(t)+iy(t)=R(t)exp[iθ(t)]

wherein z(t) is a complex domain analytic signal of x(t), θ(t) is an instantaneous phase, and R(t) is an instantaneous amplitude, and is defined as:

R(t)=\sqrt{x²(t)+y²(t)}

an instantaneous frequency f(t) is defined as a first derivative of the instantaneous phase θ(t),

$$f ( t ) = \frac{1}{2 π} \frac{d θ ( t )}{dt} .$$

the calculation formula of the instantaneous frequency is as follows:

$$f ( t ) = \frac{1}{2 π} \frac{x ( t ) {y}^{′} ( t ) - {x}^{′} ( t ) y ( t )}{{x}^{2} ( t ) + {y}^{2} ( t )} .$$

wherein, ′ denotes a derivative for time.

in the step of performing cross-correlation fitting on each of the time-frequency components of the near-well seismic traces and the synthetic seismic trace obtained by logging data of the same well, and screening out a sensitive time-frequency component with the highest correlation degree, a specific operation formula at each frequency is as follows:

max((f*g)(τ))=max(∫_{-∞}^{+∞}f*(ω,t)g(ω,t+τ)dt)

wherein,

max((f*g)(τ)) is a maximum value of the cross-correlation function,

f*(ω,t) is a certain time-frequency component of the near-well seismic trace;

g(ω,t) is a synthetic seismic trace obtained from the logging data,

t is a parameter for performing integral addition on two signals, and

τ is a parameter for a cross-correlation result, indicating different delays at which the cross-correlation values of the two signals differ.

In the step of using the sensitive time-frequency component as an input feature, and performing fuzzy C-means clustering (FCM) and spatial smoothing for seismic facies division to obtain seismic facies with set standard division, a specific operation formula comprises:

The specific operation formula comprises:

FCM tries to find a fuzzy cluster of a set of data points xⱼ∈ [symbol] ^{d}(j=1, . . . , N), minimizing a cost function:

J(U,M)=Σᵢ₌₁^{c}Σⱼ₌₁^{N}(μ_{i,j})^{m}Dᵢⱼ,

wherein, U=[μᵢⱼ]_{cxN} is a fuzzy division matrix, μi,j∈[0,1] is a membership coefficient of j^{th} data in the i^{th} cluster; M=[m₁, m₂, . . . , m_{c}] is a clustering prototype (mean or center) matrix; m∈[1, ∞) is a fuzzification parameter, usually set to 2; Dᵢⱼ=D(xⱼ, mᵢ) is a distance measure between xⱼ and mᵢ, using an Euclidean L₂ norm distance function, and the fuzzy C-means clustering method of seismic waveform comprises the steps of:

(1) selecting a time window of a waveform to be extracted, xⱼ∈ [symbol] ^{d}(j=1, . . . , N), wherein xⱼ is the jth waveform, d is the sampling number in the time window and represents a length of the window, and N is the number of waveforms;

(2) selecting appropriate values of m and c and a small positive number ε, randomly initializing the prototype matrix M, and making the step variable t=0;

(3) calculating (when t=0) or updating (when t>0) a membership matrix U:

$${μ}_{ij}^{( t + 1 )} = 1 \text{/} ( {\sum }_{l = 1}^{c} {( \frac{{D}_{lj}}{{D}_{ij}} )}^{1 \text{/} ( 1 - m )} ) ,$$

for i=1, . . . , c and j=1, . . . , N;

(4) updating the prototype matrix M:

mᵢ^{(t+1)}=(Σⱼ₌₁^{N}(μᵢⱼ^{(t+1)})^{m}xⱼ)/(Σⱼ₌₁^{N}(μᵢⱼ^{(t+1)})^{m}), where i=1, . . . ,c;

(5) repeating the steps (2)-(3) until ∥M^{(t+1)}−M^{(t)}∥<ε; and if μ_{l,j} is a largest one in μ_{i,j}(i=1, . . . , c), the jth waveform is assigned to the first cluster.

### Embodiment 2

Referring to FIG. 11, the rock reservoir structure characterization equipment provided by the embodiment 2 of the present disclosure comprises:

a three-dimensional seismic data volume acquisition unit configured for acquiring a three-dimensional seismic data volume of a key stratum of a rock reservoir to be characterized;

a data decomposition unit configured for performing a data decomposition on the three-dimensional seismic data volume of the key strata of the rock reservoir to be characterized to obtain a plurality of intrinsic mode function components;

a data transformation unit configured for performing a data transformation on all the intrinsic mode function components to obtain time-frequency spectrums of all the intrinsic mode function components, and adding the time-frequency spectrums of all the intrinsic mode functions to obtain the time-frequency spectrums of the seismic data;

a data fitting unit configured for performing a cross-correlation between each of the time-frequency components of the near-well seismic traces and the synthetic seismic trace obtained by logging data of the same well, and screening out a sensitive time-frequency component with the highest correlation degree;

a seismic facies division unit configured for using the sensitive time-frequency component with the highest correlation degree as an input feature, and performing fuzzy C-means clustering and spatial smoothing for seismic facies division to obtain seismic facies with set standard division; and

a rock reservoir structure characterization unit configured for depicting the rock reservoir to be characterized according to the seismic facies divided by the set standard to obtain the rock reservoir structure characterization to be characterized.

The rock reservoir structure characterization device provided by the disclosure is a rock reservoir structure characterization based on the fuzzy C-means clustering algorithm, can reduce the interference caused by deep weak amplitude and noise, fully extract multi-scale features of waveforms, strengthen the constraint of actual logging data, and give consideration to the transverse continuity of seismic waveforms in the process of feature extraction and classification of seismic data. Therefore, it can guarantee the noise resistance and the reliability of the clustering result, and solve the problem that the existing reservoir depiction techniques based on a data-driven machine learning method cannot guarantee validity of input features and also reliability and noise resistance of clustering.

### Embodiment 3

The computer-readable storage medium provided by the disclosure stores a rock reservoir structure characterization program, thereon which, when executed by a processor, performs the steps of the rock reservoir structure characterization method provided by the disclosure.

The computer-readable storage medium provided by the disclosure is a rock reservoir structure characterization based on the fuzzy C-means clustering algorithm, can reduce the interference caused by deep weak amplitude and noise, fully extract multi-scale features of waveforms, strengthen the constraint of actual logging data, and give consideration to the transverse continuity of seismic waveforms in the process of feature extraction and classification of seismic data. Therefore, it can guarantee the noise resistance and the reliability of the clustering result, and solve the problem that the existing reservoir depiction techniques based on a data-driven machine learning method cannot guarantee validity of input features and also reliability and noise resistance of clustering.

### Embodiment 4

The electronic equipment provided by the disclosure comprises a memory and a processor, wherein the memory stores a rock reservoir structure characterization program thereon which, when executed by the processor, performs the steps of the rock reservoir structure characterization method provided by the disclosure.

The electronic equipment provided by the disclosure is a rock reservoir structure characterization based on the fuzzy C-means clustering algorithm, can reduce the interference caused by deep weak amplitude and noise, fully extract multi-scale features of waveforms, strengthen the constraint of actual logging data, and give consideration to the transverse continuity of seismic waveforms in the process of feature extraction and classification of seismic data. Therefore, it can guarantee the noise resistance and the reliability of the clustering result, and solve the problem that the existing reservoir depiction techniques based on a data-driven machine learning method cannot guarantee validity of input features and also reliability and noise resistance of clustering.

Although preferred embodiments of the present disclosure have been described, additional variations and modifications of these embodiments will occur to those skilled in the art upon attaining the basic inventive concept. It is therefore intended that the appended claims be interpreted as including the preferred embodiments and all such variations and modifications as fall within the true scope of the present disclosure.

It will be apparent to those skilled in the art that various changes and variations can be made in the present disclosure without departing from the spirit and scope of the disclosure. Thus, it is intended that the present disclosure cover the modifications and variations provided they come within the scope of the appended claims and their equivalents.

1. A rock reservoir structure characterization method, comprising the steps of:
acquiring a three-dimensional seismic data volume of a key stratum of a rock reservoir to be characterized;
performing a data decomposition on the three-dimensional seismic data volume of the key stratum of the rock reservoir to be characterized to obtain a plurality of intrinsic mode function components;
performing a data transformation on all the intrinsic mode function components to obtain time-frequency spectrums of all the intrinsic mode function components;
adding the time-frequency spectrums of all intrinsic mode functions to obtain time-frequency spectrums of seismic data;
performing a cross-correlation between each of the time-frequency components of near-well seismic traces and a synthetic seismic trace obtained by logging data of the same well, and screening out a sensitive time-frequency component with the highest correlation degree;
using the sensitive time-frequency component with the highest correlation degree as an input feature, and performing fuzzy C-means clustering and spatial smoothing for seismic facies division to obtain seismic facies with set standard division; and
depicting the rock reservoir to be characterized according to the seismic facies divided by the set standard to obtain the rock reservoir structure characterization.

2. The rock reservoir structure characterization method according to claim 1, wherein, in the step of performing a data decomposition on the three-dimensional seismic data volume of the key stratum of the rock reservoir to be characterized to obtain a plurality of intrinsic mode function components, the data decomposition specifically adopts a complete ensemble empirical mode decomposition with adaptive noise method.

3. The rock reservoir structure characterization method according to claim 1, wherein, in the step of performing a data transformation on all the intrinsic mode function components to obtain time-frequency spectrums of all the intrinsic mode function components, a Hilbert transformation method is specifically adopted for performing the data transformation on all the intrinsic mode function components.

4. The rock reservoir structure characterization method according to claim 1, wherein, in the step of performing a data decomposition on the three-dimensional seismic data volume of the key stratum of the rock reservoir to obtain a plurality of intrinsic mode function components, a specific operation formula comprises:
letting x[n] be target data, and a complete ensemble empirical mode decomposition with adaptive noise and computation of time-frequency spectrums being described by the following algorithm:
(1) subjecting all xⁱ[n]=x[n]+ε₀wⁱ[n](i=1, 2, . . . , I) to the empirical mode decomposition (EMD) to obtain their first mode IMF₁ⁱ [n], and calculating
$$\frac{1}{I} {\sum }_{i = 1}^{I} {IMF}_{1}^{i} [ n ] = \overline{{IMF}_{1}} [ n ]$$
wherein, x[n] is a seismic trace signal, wⁱ[n](i=1, 2, . . . , I) are different white Gaussian noises;
(2) calculating a first residual error in the first stage (k=1), as shown in the following formula:
r1[n]=x[n]− [symbol] [n]
(3) decomposing to implement r1[n]+ε1E1(wⁱ[n]), I=1, . . . , I, until the first EMD mode is acquired for defining a second mode:
$$[ n ] = \frac{1}{I} {\sum }_{i = 1}^{I} {E}_{1} ( {r}_{1} [ n ] + {ɛ}_{1} {E}_{1} ( {w}^{i} [ n ] ) )$$
(4) for k=2, . . . , K, calculating a kth residual error:
rₖ[n]=r₍ₖ₋₁₎[n]− [symbol] [n]
(5) decomposing to implement rₖ[n]+εₖEₖ(wⁱ[n]), i=1, . . . , I, until the first EMD mode is acquired for defining a (k+1)ₜₕ mode:
$${{( k + 1 )}_{[ n ]}}_{} = \frac{1}{I} {\sum }_{i = 1}^{I} {E}_{1} ( {r}_{k} [ n ] + {ɛ}_{k} {E}_{k} ( {w}^{i} [ n ] ) )$$
(6) going to a fourth step in the next k;
circularly executing steps (4)-(6) until the obtained residual error is no longer decomposable, i.e. the residual error has at most one pole, and the final residual error satisfies:
R[n]=x[n]−Σₖ₌₁^{K} [symbol]
wherein K represents the total number of modes; thus, a given signal x[n] is represented as:
x[n]=Σₖ₌₁^{K} [symbol] +R[n].

5. The rock reservoir structure characterization method according to claim 1, wherein, in the step of performing data transformation on all the intrinsic mode function components to obtain time-frequency spectrums of all the intrinsic mode function components, a specific operation formula comprises:
$$y ( t ) = H [ x ( t ) ] = x ( t ) * \frac{1}{π t}$$
wherein x(t) is each intrinsic mode function IMF, y(t) is a Hilbert transform of x(t), and * represents a convolution symbol;
z(t)=x(t)+iy(t)=R(t)exp[iθ(t)]
wherein z(t) is a complex domain analytic signal of x(t), θ(t) is an instantaneous phase, and R(t) is an instantaneous amplitude, and is defined as:
R(t)=\sqrt{x²(t)+y²(t)}
an instantaneous frequency f(t) is defined as a first derivative of the instantaneous phase θ(t),
$$f ( t ) = \frac{1}{2 π} \frac{d θ ( t )}{dt} \text{;}$$
the calculation formula of the instantaneous frequency is as follows:
$$f ( t ) = \frac{1}{2 π} \frac{x ( t ) {y}^{′} ( t ) - {x}^{′} ( t ) y ( t )}{{x}^{2} ( t ) + {y}^{2} ( t )} \text{;}$$
wherein, ′ denotes a derivative for time.

6. The rock reservoir structure characterization method according to claim 1, wherein, in the step of performing a cross-correlation between each of the time-frequency components of the near-well seismic traces and the synthetic seismic trace obtained by logging data of the same well, and screening out a sensitive time-frequency component with the highest correlation degree, a specific operation formula at each frequency is as follows:
max((f*g)(τ))=max(∫_{-∞}^{+∞}f*(ω,t)g(ω,t+τ)dt),
wherein,
max((f*g)(τ)) is a maximum value of the cross-correlation function,
f*(ω,t) is a certain time-frequency component of the near-well seismic trace,
g(ω,t) is a synthetic seismic trace obtained from the logging data,
t is a parameter for performing integral addition on two signals, and
τ is a parameter for a cross-correlation result, indicating different delays at which the cross-correlation values of the two signals differ.

7. The rock reservoir structure characterization method according to claim 1, wherein, in the step of using the sensitive time-frequency component as an input feature, and performing fuzzy C-means clustering (FCM) and spatial smoothing for seismic facies division to obtain seismic facies with set standard division, a specific operation formula comprises:
FCM trying to find a fuzzy cluster of a set of data points xⱼ∈ [symbol] ^{d}(j=1, . . . , N), minimizing a cost function:
J(U,M)=Σᵢ₌₁^{c}Σⱼ₌₁^{N}(μ_{i,j})^{m}Dᵢⱼ,
wherein, U=[μ_{i,j}]cx^{N} is a fuzzy division matrix, μi,j∈[0,1] is a membership coefficient of jth data in the ith cluster; M=[m1, m2, . . . , mc] is a clustering prototype (mean or center) matrix; m∈[1, ∞) is a fuzzification parameter, usually set to 2; Dij=D(xj, mi) is a distance measure between xj and mi, using an Euclidean L2 norm distance function, and the fuzzy C-means clustering method of seismic waveform comprises the steps of:
(1) selecting a time window of a waveform to be extracted, xⱼ∈ [symbol] ^{d}(j−1, . . . , N), wherein xⱼ is the jₜₕ waveform, d is the sampling number in the time window and represents a length of the window, and N is the number of waveforms;
(2) selecting appropriate values of m and c and a small positive number ε, randomly initializing a prototype matrix M, and making the step variable t=0;
(3) calculating (when t=0) or updating (when t>0) a membership matrix U:
$${μ}_{ij}^{( t + 1 )} = 1 \text{/} {\sum }_{l = 1}^{c} {( \frac{{D}_{lj}}{{D}_{ij}} )}^{1 \text{/} ( 1 - m )} ,$$
for i=1, . . . , c and j=1, . . . , N;
(4) updating the prototype matrix M:
mᵢ^{(t+1)}=(Σⱼ₌₁^{N}(μᵢⱼ^{(t+1)})^{m}xⱼ)/(Σⱼ₌₁^{N}(μᵢⱼ^{(t+1)})^{m}), where i=1, . . . ,c;
(5) repeating the steps (2)-(3) until ∥M^{(t+1)}−M^{(t)}∥<ε; and if μ_{l,j} is a largest one in μ_{i,j}(i=1, . . . , c), the jₜₕ waveform is assigned to the 1ₜₕ cluster.

8. A rock reservoir structure characterization device, comprising:
means for acquiring a three-dimensional seismic data volume of a key stratum of a rock reservoir to be characterized by a three-dimensional seismic data volume acquisition unit;
means for performing a data decomposition on the three-dimensional seismic data volume of the key stratum of the rock reservoir to be characterized to obtain a plurality of intrinsic mode function components by a data decomposition unit;
means for performing data transformation on all the intrinsic mode function components to obtain time-frequency spectrums of all the intrinsic mode function components, and adding the time-frequency spectrums of all the intrinsic mode functions to obtain the time-frequency spectrums of the seismic data by a data transformation unit;
means for performing cross-correlation between each of the time-frequency components of near-well seismic traces and a synthetic seismic trace obtained by logging data of the same well, and screening out a sensitive time-frequency component with the highest correlation degree by a data fitting unit;
means for using the sensitive time-frequency component with the highest correlation degree as an input feature, and performing fuzzy C-means clustering and spatial smoothing for seismic facies division to obtain seismic facies with set standard division by a seismic facies division unit; and
means for depicting the rock reservoir to be characterized according to the seismic facies divided by the set standard to obtain the rock reservoir structure characterization to be characterized by a rock reservoir structure characterization unit.

9. A non-transitory computer-readable storage medium, storing a rock reservoir structure characterization program thereon which, when executed by a processor, performs the steps of the rock reservoir structure characterization method of claim 1.

10. An electronic equipment, comprising a memory and a processor, wherein the memory stores a rock reservoir structure characterization program thereon which, when executed by the processor, performs the steps of the rock reservoir structure characterization method of claim 1.
